(19) United States
(12) Patent Application Publication
(10) Pub. No.: US 2020/0234401 A1
(43) Pub. Date: Jul. 23, 2020

(54) DISPLAY APPARATUS AND METHOD OF PRODUCING IMAGES USING ROTATABLE OPTICAL ELEMENT

(71) Applicant: Varjo Technologies Oy, Helsinki (FI)

(72) Inventors: Mikko Ollila, Tampere (FI); Klaus Melakari, Oulu (FI)

(21) Appl. No.: 16/254,008

(22) Filed: Jan. 22, 2019

(51) Int. Cl. G06T 3/00; G09G 5/10

(52) U.S. Cl. CPC G06T 3/0093; G09G 5/10; G09G 2340/0407; G09G 2320/0233; G09G 2354/00

(57) ABSTRACT

A display apparatus includes image renderer per eye, optical element arranged on optical path between image renderer and image plane, means for detecting gaze direction of user with respect to image plane, and processor coupled to image renderer and said means. The processor or an image source is configured to generate warped image based upon detected gaze direction and different optical properties of first and second optical portions of optical element. The processor is configured to control image renderer to render warped image, whilst controlling rotational orientation of optical element such that first and second optical portions are oriented according to detected gaze direction of user. Projections of first portion and second portion of the warped image are differently magnified by first optical portion and second optical portion, respectively, to produce on image plane an image having spatially-variable angular resolution such that produced image appears de-warped to user.

### TECHNICAL FIELD

The present disclosure relates generally to display apparatuses; and more specifically, to display apparatuses for producing images having spatially-variable angular resolutions. Moreover, the present disclosure also relates to methods of producing images having spatially-variable angular resolutions.

### BACKGROUND

Nowadays, several specialized devices (for example, such as Augmented Reality (AR) headsets, Mixed Reality (MR) headsets, and the like) allow users to experience and interact with simulated environments (for example, such as AR, MR and the like). Such simulated environments enhance a user's experience of reality around him/her and provide the user with a feeling of immersion within the simulated environments, using contemporary techniques such as stereoscopy. Such specialized devices are commonly known as Head-Mounted Displays (HMDs).

Such HMDs are often video see-through devices that display a sequence of images upon display screens. Typically, an HMD displays different images of a given visual scene on separate display screens for left and right eyes of a user. As a result, the user is able to perceive a stereoscopic depth within the given visual scene.

However, conventional HMDs suffer from several disadvantages. Firstly, display screens used in the conventional HMDs are small in size. As a result, pixel densities offered by such display screens are insufficient to imitate a visual acuity of human eyes, so much so that display screens offering higher pixel densities are dimensionally too large to be accommodated in HMDs. Secondly, display screens used in the conventional HMDs require a large number of optical components to properly render a simulated environment along with an implementation of gaze contingency as in the human visual system. Such large numbers of optical components are difficult to accommodate in the HMDs. Consequently, the conventional HMDs are not sufficiently well-developed and are limited in their ability to mimic the human visual system.

In light of the foregoing discussion, there exists a need to overcome the aforementioned drawbacks associated with conventional display apparatuses.

### SUMMARY

The present disclosure seeks to provide a display apparatus for producing an image having a spatially-variable angular resolution on an image plane. The present disclosure also seeks to provide a method of producing an image having a spatially-variable angular resolution on an image plane. An aim of the present disclosure is to provide a solution that overcomes at least partially the problems encountered in prior art.

In a first aspect, an embodiment of the present disclosure provides a display apparatus for producing an image having a spatially-variable angular resolution on an image plane, the display apparatus comprising:
an image renderer per eye;
at least one optical element arranged on an optical path between the image renderer and the image plane, the at least one optical element comprising at least a first optical portion and a second optical portion having different optical properties with respect to magnification, the at least one optical element being rotatable;
means for detecting a gaze direction of a user with respect to the image plane; and
a processor coupled to the image renderer and said means, wherein the processor or an image source communicably coupled to the processor is configured to generate a warped image based upon the detected gaze direction of the user and the optical properties of the first optical portion and the second optical portion,

wherein the processor is configured to control the image renderer to render the warped image, whilst controlling a rotational orientation of the at least one optical element in a manner that the first optical portion and the second optical portion are oriented according to the detected gaze direction of the user, wherein projections of a first portion and a second portion of the warped image are to be differently magnified by the first optical portion and the second optical portion, respectively, to produce the image on the image plane in a manner that the produced image appears de-warped to the user.

In a second aspect, an embodiment of the present disclosure provides a method of producing an image having a spatially-variable angular resolution on an image plane, the method being implemented via a display apparatus comprising
an image renderer and at least one optical element arranged on an optical path between the image renderer and the image plane, the method comprising:
detecting a gaze direction of a user with respect to the image plane;
generating a warped image based upon the detected gaze direction of the user and optical properties of a first optical portion and a second optical portion of the at least one optical element, wherein the first optical portion and the second optical portion have different optical properties with respect to magnification; and
rendering the warped image via the image renderer, whilst controlling a rotational orientation of the at least one optical element in a manner that the first optical portion and the second optical portion are oriented according to the detected gaze direction of the user, wherein projections of a first portion and a second portion of the warped image are differently magnified by the first optical portion and the second optical portion, respectively, to produce the image on the image plane in a manner that the produced image appears de-warped to the user.

Embodiments of the present disclosure substantially eliminate or at least partially address the aforementioned problems in the prior art, and facilitate production of a sequence of de-warped images having spatially-variable angular resolutions on an image plane, without increasing computational burden and a complexity of computational hardware.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1 and 2 are schematic diagrams of a display apparatus, in accordance with different embodiments of the present disclosure;

FIG. 3 is a schematic illustration of how different portions of a warped image are differently magnified by at least one optical element to produce an image on an image plane, in accordance with an embodiment of the present disclosure;

FIG. 4A is an example illustration of a warped image as rendered via an image renderer, in accordance with an embodiment of the present disclosure; FIG. 4B is an example illustration of an image that is produced on an image plane when the warped image passes through or reflects from at least one optical element arranged on an optical path between the image renderer and the image plane, in accordance with an embodiment of the present disclosure;

FIGS. 5A, 5B and 5C are example schematic illustrations of de-warped portions of images that are produced on an image plane, in accordance with different embodiments of the present disclosure;

FIGS. 6A and 6B are example graphical representations of an angular resolution of a produced image as a function of an angular distance between a centre of a first de-warped portion of the produced image and an edge of the produced image, in accordance with different embodiments of the present disclosure;

FIG. 7A is a schematic illustration of an example implementation where a symmetrical optical element is rotated with respect to an image renderer that renders a warped image, while FIG. 7B is an example graphical representation of an angular resolution of a de-warped portion of an image produced on an image plane as a function of an angular distance between the de-warped portion of the produced image and a centre of the produced image, the warped image being optically de-warped using the symmetrical optical element to produce said image, in accordance with an embodiment of the present disclosure;

FIG. 8A is a schematic illustration of another example implementation where an asymmetrical optical element is rotated with respect to an image renderer that renders a warped image, while FIG. 8B is an example graphical representation of an angular resolution of a de-warped portion of an image produced on an image plane as a function of an angular distance between the de-warped portion of the produced image and a centre of the produced image, the warped image being optically de-warped using the asymmetrical optical element to produce said image, in accordance with another embodiment of the present disclosure; and

FIG. 9 illustrates steps of a method of producing an image having a spatially variable resolution on an image plane, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a display apparatus for producing an image having a spatially-variable angular resolution on an image plane, the display apparatus comprising:
an image renderer per eye;
at least one optical element arranged on an optical path between the image renderer and the image plane, the at least one optical element comprising at least a first optical portion and a second optical portion having different optical properties with respect to magnification, the at least one optical element being rotatable;
means for detecting a gaze direction of a user with respect to the image plane; and
a processor coupled to the image renderer and said means, wherein the processor or an image source communicably coupled to the processor is configured to generate a warped image based upon the detected gaze direction of the user and the optical properties of the first optical portion and the second optical portion,
   wherein the processor is configured to control the image renderer to render the warped image, whilst controlling a rotational orientation of the at least one optical element in a manner that the first optical portion and the second optical portion are oriented according to the detected gaze direction of the user, wherein projections of a first portion and a second portion of the warped image are to be differently magnified by the first optical portion and the second optical portion, respectively, to produce the image on the image plane in a manner that the produced image appears de-warped to the user.

In a second aspect, an embodiment of the present disclosure provides a method of producing an image having a spatially-variable angular resolution on an image plane, the method being implemented via a display apparatus comprising
an image renderer and at least one optical element arranged on an optical path between the image renderer and the image plane, the method comprising:
detecting a gaze direction of a user with respect to the image plane;
generating a warped image based upon the detected gaze direction of the user and optical properties of a first optical portion and a second optical portion of the at least one optical element, wherein the first optical portion and the second optical portion have different optical properties with respect to magnification; and
rendering the warped image via the image renderer, whilst controlling a rotational orientation of the at least one optical element in a manner that the first optical portion and the second optical portion are oriented according to the detected gaze direction of the user, wherein projections of a first portion and a second portion of the warped image are differently magnified by the first optical portion and the second optical portion, respectively, to produce the image on the image plane in a manner that the produced image appears de-warped to the user.

The aforementioned display apparatus and method are susceptible to be used for producing, on the image plane, a sequence of de-warped images having spatially-variable angular resolutions, without increasing computational burden and a complexity of computational hardware. The display apparatus and method utilize the at least one optical element to optically de-warp a sequence of warped images into the sequence of de-warped images, wherein the angular resolutions of these de-warped images vary spatially across the image plane.

Beneficially, when rendered, the warped image has a same angular resolution across an image rendering surface of the image renderer (namely, a surface of the image renderer on which the warped image is rendered). Upon being differently magnified, the projections of the first portion and the second portion of the warped image produce on the image plane a first de-warped portion and a second de-warped portion of the produced image, respectively. The terms “produced image” and “image produced on the image plane” have been used interchangeably throughout the present disclosure, to refer to the image that is made visible to the user on the image plane.

Throughout the present disclosure, the term “image plane” refers to an imaginary plane on which the produced image is visible to the user. Optionally, the image plane is at a distance that lies in a range of 25 cm to 400 cm from a perspective of a user's eye. More optionally, the image plane is at a distance that lies in a range of 50 cm to 100 cm from the perspective of the user's eye.

Pursuant to embodiments of the present disclosure, the angular resolution of the produced image varies spatially in a manner that an angular resolution of the first de-warped portion of the produced image is greater than an angular resolution of the second de-warped portion of the produced image. Throughout the present disclosure, the term “first de-warped portion of the produced image” refers to a region of interest of the produced image at which the user is gazing, whereas the term “second de-warped portion of the produced image” refers to a remaining region of the produced image or a part of the remaining region. In other words, the first de-warped portion of the produced image is a portion of the produced image whose image is formed on and around a fovea of the user's eye, whereas the second de-warped portion of the produced image is a portion of the produced image whose image is formed on a remaining part of a retina of the user's eye. Beneficially, the angular resolution of the first de-warped portion is comparable to a normal human-eye resolution. Therefore, the produced image having such a spatially-variable angular resolution mimics foveation characteristics of the human visual system.

Optionally, the angular resolution of the first de-warped portion of the produced image is greater than or equal to twice the angular resolution of the second de-warped portion of the produced image. More optionally, the angular resolution of the first de-warped portion of the produced image is greater than or equal to six times the angular resolution of the second de-warped portion of the produced image. As an example, the angular resolution of the first de-warped portion may be approximately 90 pixels per degree, while the angular resolution of the second de-warped portion may be approximately 15 pixels per degree. Yet more optionally, the angular resolution of the first de-warped portion of the produced image is greater than or equal to ten times the angular resolution of the second de-warped portion of the produced image. As an example, the angular resolution of the first de-warped portion may be approximately 100 pixels per degree, while the angular resolution of the second de-warped portion may be approximately 10 pixels per degree.

Moreover, optionally, the angular resolution of the produced image decreases non-linearly on going from a centre of the first de-warped portion towards an edge of the produced image.

Alternatively, optionally, the angular resolution of the produced image decreases linearly on going from the centre of the first de-warped portion towards the edge of the produced image.

Yet alternatively, optionally, the angular resolution of the produced image decreases in a step-wise manner on going from the centre of the first de-warped portion towards the edge of the produced image. Optionally, in such a case, the first de-warped portion of the produced image has a first constant angular resolution, whereas the second de-warped portion of the produced image has a second constant angular resolution.

Throughout the present disclosure, the term “angular resolution” of a given image refers to a number of pixels per degree (namely, points per degree (PPD)) of an angular width of a given portion of the given image, wherein the angular width is measured from the perspective of the user's eye.

Optionally, an angular width of the first de-warped portion of the produced image lies in a range of 5 degrees to 60 degrees, while an angular width of the second de-warped portion of the produced image lies in a range of 40 degrees to 220 degrees. Herein, the term “angular width” refers to an angular width of a given portion of the produced image with respect to the perspective of the user's eye, namely with respect to a centre of the user's gaze. It will be appreciated that the angular width of the second de-warped portion is larger than the angular width of the first de-warped portion. The angular width of the second de-warped portion of the produced image may, for example, be 40, 50, 60, 70, 80, 90, 100, 110, 120, 130, 140, 150, 160, 170, 180, 190, 200, 210 or 220 degrees, or any other intermediate value. Likewise, the angular width of the first de-warped portion of the produced image may, for example, be 5, 10, 15, 20, 25, 30, 35, 40, 45, 50, 55 or 60 degrees, or any other intermediate value.

Furthermore, throughout the present disclosure, the term “at least one optical element” refers to a configuration of one or more optical elements (for example, such as lenses, mirrors, prisms and so forth) that is capable of differently magnifying projections passing therethrough or reflecting therefrom. When the first and second optical portions of the at least one optical element are aligned with the first and second portions of the warped image rendered at the image renderer, the projections of the first and second portions of the warped image are differently magnified by the first and second optical portions, respectively, to yield the produced image that appears de-warped to the user (namely, that does not appear warped to the user).

Pursuant to embodiments of the present disclosure, when generating the warped image, the processor or the image source is configured to generate the first and second portions of the warped image based upon the optical properties of the first and second optical portions. It will be appreciated that it is possible to align the first and second optical portions of the at least one optical element with the first and second portions of the warped image accurately, because the detected gaze direction of the user is taken into consideration during the generation of the warped image as well as while controlling the rotational orientation of the at least one optical element. When aligned with the first and second portions of the warped image, the first and second optical portions of the at least one optical element apply a de-warping effect that is an inverse of a warping effect that was applied during the generation of the warped image.

Throughout the present disclosure, the term “projections of the first and second portions of the warped image” refers to a collection of light rays emanating from the image renderer when the warped image is rendered thereat. The projections of the first and second portions of the warped image (namely, the collection of light rays) may transmit through and/or reflect from the at least one optical element and various other components of the display apparatus before reaching the user's eye. For purposes of embodiments of the present disclosure, the term “projections of the first and second portions of the warped image” has been used consistently, irrespective of whether the collection of light rays is transmitted or reflected.

Optionally, the at least one optical element is implemented as at least one of: a lens, a mirror, a prism.

Optionally, the at least one optical element is implemented as a single lens having a complex shape. As an example, such a lens may have an aspheric shape. Optionally, the single lens is implemented as any of: a Fresnel lens, a Liquid Crystal (LC) lens or a liquid lens.

Alternatively, optionally, the at least one optical element is implemented as a single mirror having a complex shape. As an example, a reflective surface of such a mirror may have an aspheric shape.

Yet alternatively, optionally, the at least one optical element is implemented as a configuration of multiple lenses and/or mirrors. Optionally, in such a case, the first optical portion and the second optical portion are implemented as separate optical elements.

Moreover, throughout the present disclosure, by the phrase “differently magnified”, any of the following is meant:
the first optical portion would de-magnify the projection of the first portion of the warped image, while the second optical portion would magnify the projection of the second portion of the warped image;
both the first optical portion and the second optical portion would de-magnify the projections of the first portion and the second portion of the warped image, respectively, wherein a de-magnification power of the first optical portion is greater than a de-magnification power of the second optical portion;
the first optical portion would de-magnify the projection of the first portion of the warped image, while the second optical portion would neither magnify nor de-magnify the projection of the second portion of the warped image;
the first optical portion would neither magnify nor de-magnify the projection of the first portion of the warped image, while the second optical portion would magnify the projection of the second portion of the warped image; or
both the first optical portion and the second optical portion would magnify the projections of the first portion and the second portion of the warped image, respectively, wherein a magnification power of the second optical portion is greater than a magnification power of the first optical portion.

Throughout the present disclosure, the term “magnification power” refers to an extent to which a given portion of the warped image would appear enlarged when viewed through a given optical portion of the at least one optical element, while the term “de-magnification power” refers to an extent to which a given portion of the warped image would appear shrunk when viewed through a given optical portion of the at least one optical element.

Moreover, optionally, the at least one optical element further comprises at least one intermediary optical portion between the first optical portion and the second optical portion, the at least one intermediary optical portion having different optical properties with respect to magnification as compared to the first optical portion and the second optical portion. Notably, the at least one intermediary optical portion could comprise a single intermediary optical portion or a plurality of intermediary optical portions. Throughout the present disclosure, the term “intermediary optical portion” refers to a portion of the at least one optical element that lies between the first optical portion and the second optical portion. In other words, an intermediary optical portion is a portion of the at least one optical element that surrounds the first optical portion, and is surrounded by the second optical portion.

Hereinafter, the phrase “different optical properties with respect to magnification” is interchangeably referred to as “different magnification and/or de-magnification properties”, for the sake of convenience only.

By the phrase “different optical properties with respect to magnification”, it is meant that the first optical portion and the second optical portion, and optionally, the at least one intermediary optical portion have different magnification and/or de-magnification properties, and are capable of selectively magnifying and/or de-magnifying projections of different portions of the warped image rendered at the image renderer. As an example, each of the first optical portion, the second optical portion and the at least one intermediary optical portion may de-magnify the projections of the different portions of the warped image, wherein a de-magnification power of the at least one intermediary optical portion is greater than the de-magnification power of the second optical portion, but smaller than the de-magnification power of the first optical portion. As another example, the at least one intermediary optical portion may neither magnify nor de-magnify a projection of an intermediary portion of the warped image (namely, a portion between the first portion and the second portion of the warped image), while the first optical portion and the second optical portion may, respectively, de-magnify and magnify the projections of the first portion and the second portion of the warped image.

Optionally, the de-magnification power (and optionally, the magnification power) of the aforementioned optical portions of the at least one optical element is to vary spatially according to an optical transfer function. Optionally, in this regard, the de-magnification power (and optionally, the magnification power) of the different optical portions of the at least one optical element is to vary from an optical centre of the first optical portion towards an edge of the at least one optical element according to the optical transfer function.

Optionally, the optical transfer function defines how the de-magnification power (and optionally, the magnification power) varies at different optical portions of the at least one optical element. More optionally, the optical transfer function is a function of two variables, wherein the two variables correspond to X and Y coordinates with respect to the optical centre of the first optical portion. Optionally, in such a case, the magnification and/or de-magnification properties of the at least one optical element vary differently along X and Y axes.

The rotation of the at least one optical element induces a spatial shift and rotation of the optical transfer function on the image plane. It will be appreciated that the X and Y axes are not fixed with respect to the image plane, but are rotated as per the rotational orientation of the at least one optical element.

The optical transfer function could be a linear gradient function, a non-linear gradient function or a step gradient function. Optionally, when the optical transfer function is a linear gradient function or a non-linear gradient function, the de-magnification power (and optionally, the magnification power) of the first optical portion, the at least one intermediary optical portion and the second optical portion do not change abruptly as discrete values, rather they change smoothly according to the optical transfer function.

In an example case where the optical transfer function is a linear gradient function, the de-magnification power of the at least one optical element would change linearly and uniformly on going from the optical centre of the first optical portion towards the edge of the at least one optical element. In another example case where the optical transfer function is a non-linear gradient function, the de-magnification power of the at least one optical element would change non-linearly on going from the optical centre of the first optical portion towards the edge of the at least one optical element.

In yet another example case where the optical transfer function is a step gradient function, the de-magnification power of the at least one optical element would change step wise on going from the optical centre of the first optical portion towards the edge of the at least one optical element. Optionally, in such a case, the at least one optical element comprises a flat lens with a first optical power and a second optical power in the first optical portion and the second optical portion, respectively. Such an optical element is easy to manufacture.

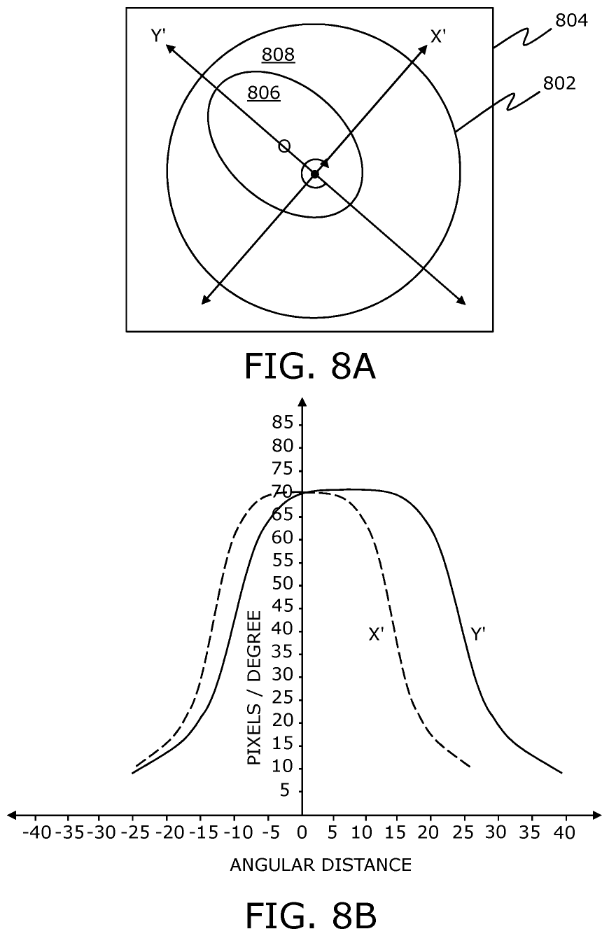

Furthermore, according to an embodiment, the at least one optical element is asymmetrical with respect to its optical axis. Optionally, in such a case, the first optical portion and the second optical portion are positioned asymmetrically with respect to the optical axis of the at least one optical element. One such asymmetrical optical element has been illustrated in conjunction with FIG. 8A.

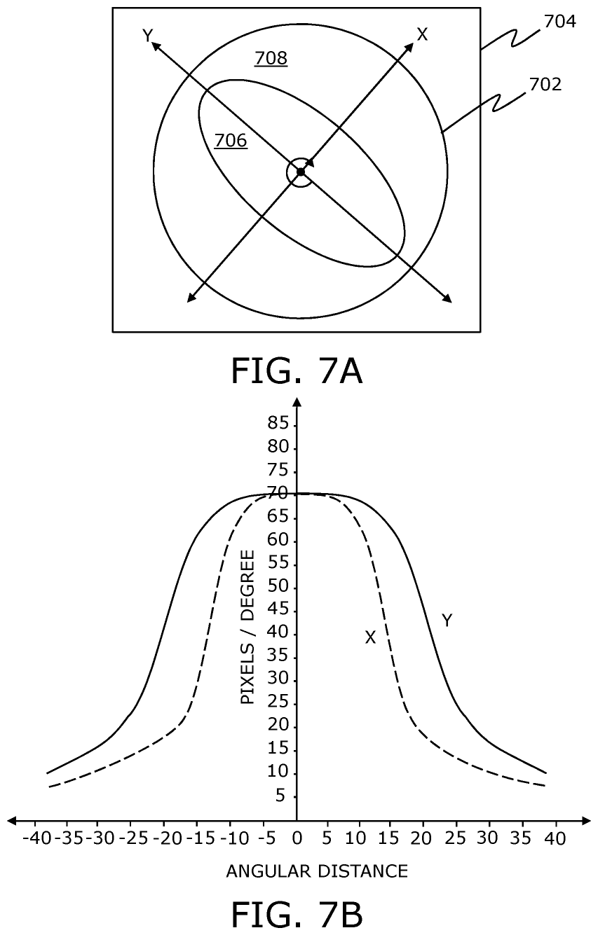

According to another embodiment, the at least one optical element is symmetrical with respect to its optical axis. Optionally, in such a case, the first optical portion surrounds an optical centre of the at least one optical element, while the second optical portion surrounds the first optical portion. Additionally, optionally, the second optical portion is surrounded by a periphery of the at least one optical element. One such symmetrical optical element has been illustrated in conjunction with FIG. 7A.

Optionally, the first optical portion and/or the second optical portion have a substantially circular shape. Alternatively, optionally, the first optical portion and/or the second optical portion have a substantially elliptical shape. The terms “substantially circular” and “substantially elliptical” refer to a given shape that approximates a circle and an ellipse, respectively, within +/−20%, and more optionally, within +/−5%.

Optionally, when the at least one optical element is symmetrical with respect to its optical axis, the first optical portion and the second optical portion are concentric to each other.

More optionally, the shape of the first optical portion and/or the second optical portion is defined based upon an aspect ratio of the produced image (namely, an aspect ratio that is desired for the produced image). In an example, if the aspect ratio of 16:9 is required, the first optical portion and/or the second optical portion may have a substantially elliptical shape. In another example, if the aspect ratio of 1:1 is required, the first optical portion and/or the second optical portion may have a substantially circular shape.

Optionally, when there are one or more intermediary optical portions between the first optical portion and the second optical portion, the shape of such intermediary optical portions is similar to the shape of the first optical portion and/or the second optical portion.

Moreover, optionally, the image source comprises a processor configured to generate computer graphics.

Additionally or alternatively, the image source comprises an imaging unit comprising at least one camera and at least one warping optical element. Optionally, the at least one warping optical element comprises a first warping portion and a second warping portion, wherein optical properties of the first and second warping portions of the at least one warping optical element are substantially inverse of the optical properties of the first and second optical portions of the at least one optical element, respectively. By “substantially inverse”, it is meant that the first and second portions of the warped image (that were generated using the first and second warping portions), when rendered at the image renderer, can be optically de-warped by the first and second optical portions of the at least one optical element, to produce the image that appears de-warped to the user.

Optionally, in a case where the imaging unit is employed, projections of a first region and a second region of a given real-world scene are differently magnified by the first warping portion and the second warping portion of the at least one warping optical element to generate the first portion and the second portion of the warped image, respectively. Optionally, in this regard, a number of pixels employed for capturing a particular angular width (namely, the PPD) of the first region of the given real-world scene is greater than a number of pixels employed for capturing that particular angular width (namely, the PPD) of the second region of the given real-world scene.

In some implementations, the imaging unit is integrated with the display apparatus. As an example, the imaging unit could be mounted, for example, on an outer surface of the display apparatus, such that the at least one camera faces the given real-world scene.

In other implementations, the imaging unit is implemented on a remote device that is separate from the display apparatus. Optionally, the imaging unit is mounted on the remote device. In such implementations, the imaging unit and the display apparatus are communicably coupled via a wired interface or a wireless interface.

Optionally, the remote device is physically positioned at the given real-world scene, whereas the user of the display apparatus is positioned away from (for example, at a distance from) the remote device. In such an implementation, the imaging unit and the display apparatus are communicably coupled via a wired interface or a wireless interface.

Optionally, in this implementation, the display apparatus comprises means for tracking a head orientation of a user, wherein the head orientation is to be tracked when the display apparatus in operation is worn by the user. Throughout, the present disclosure, the term “means for tracking a head orientation” refers to specialized equipment for detecting and optionally, following the orientation of the user's head, when the display apparatus is worn by the user. Optionally, the means for tracking the head orientation of the user is implemented by way of a gyroscope and an accelerometer.

Optionally, in this regard, the imaging unit further comprises:
at least one actuator attached to a base that supports the at least one warping optical element and the at least one camera; and
a processor coupled to the at least one camera and the at least one actuator, wherein the processor is configured to:
receive, from the display apparatus, information indicative of the current head orientation and gaze direction of the user; and
control the at least one actuator to adjust an orientation of the at least one warping optical element and the at least one camera, based upon the current head orientation and gaze direction of the user.

A visual scene so presented to the user conforms to a current perspective of the user. This provides a greater sense of immersion to the user.

Throughout the present disclosure, the term “display apparatus” refers to specialized equipment that is configured to present a simulated environment to the user when the display apparatus in operation is worn by the user on his/her head. In such an instance, the display apparatus acts as a device (for example, such as an Augmented Reality (AR) headset, a pair of AR glasses, a Mixed Reality (MR) headset, a pair of MR glasses and so forth) that is operable to present a visual scene of the simulated environment to the user. In an example, the visual scene may be an educational augmented reality video. In another example, the visual scene may be a mixed reality game.

The processor could be implemented as hardware, software, firmware or a combination of these. The processor is coupled to various components of the display apparatus, and is configured to control the operation of the display apparatus.

Throughout the present disclosure, the term “means for detecting a gaze direction” refers to specialized equipment for detecting and/or tracking the gaze direction of the user. Such specialized equipment are well known in the art. For example, the means for detecting the gaze direction can be implemented using contact lenses with sensors, cameras monitoring a position of a pupil of the user's eye, infrared (IR) light sources and IR cameras, a bright pupil-detection technique, a dark pupil-detection technique and the like. Beneficially, said means is arranged in a manner that it does not cause any obstruction in the user's view.

It will be appreciated that said means is employed to detect the gaze direction of the user repeatedly over a period of time, when the display apparatus in operation is worn by the user. Optionally, the processor or the image source is configured to generate the sequence of warped images, based upon instantaneous gaze directions of the user detected during operation, in real-time or near real-time.

The sequence of warped images is then rendered via the image renderer, while the at least one optical element is rotated to orient the first optical portion and the second optical portion according to the instantaneous gaze directions of the user. Upon being differently magnified, projections of different portions of these warped images produce the sequence of de-warped images. The sequence of de-warped images creates the visual scene of the simulated environment that is presented to the user.

Throughout the present disclosure, the term “image renderer” refers to equipment that, when operated, renders a sequence of warped images. Beneficially, the image renderer has a same display resolution throughout its array of pixels. In other words, the image renderer has a same pixel density throughout the entire array of pixels. When the warped image is rendered via the image renderer, the projections of the first and second portions of the warped image emanate from the image rendering surface of the image renderer.

Optionally, the image renderer is implemented as a display. Optionally, the display is selected from the group consisting of: a Liquid Crystal Display (LCD), a Light Emitting Diode (LED)-based display, an Organic LED (OLED)-based display, a micro OLED-based display, a Liquid Crystal on Silicon (LCoS)-based display, and a Cathode Ray Tube (CRT)-based display.

As an example, the image renderer may be implemented as an LCD having a backlight. The backlight may be an LED-based light source, a Xenon flash-based light source, a laser-based light source or similar.

Optionally, the image renderer is implemented as a projector and a projection screen associated therewith. Optionally, the projector is selected from the group consisting of: an LCD-based projector, an LED-based projector, an OLED-based projector, an LCoS-based projector, a Digital Light Processing (DLP)-based projector, and a laser projector.

Furthermore, optionally, when generating the warped image, the processor or the image source is configured to adjust an intensity of the first portion and the second portion of the warped image in a manner that, upon being differently magnified, the projections of the first portion and the second portion of the warped image produce the image on the image plane that appears to have a uniform brightness across the image.

This enables the display apparatus to avoid an increase in brightness in the first de-warped portion of the produced image as compared to the second de-warped portion of the produced image. Notably, pixels of the first de-warped portion appear smaller than pixels of the second de-warped portion. If the intensity of the first portion and the second portion of the warped image is not adjusted, the pixels of the first de-warped portion would appear brighter than the pixels of the second de-warped portion.

Optionally, in this regard, the intensity of the first portion and the second portion of the warped image is adjusted by decreasing the intensity of the first portion of the warped image, and/or by increasing the intensity of the second portion of the warped image.

Moreover, optionally, when generating the warped image, the processor or the image source is configured to blend a boundary region between the first portion and the second portion of the warped image, so as to smoothen any abrupt change in the first portion and the second portion of the warped image. Optionally, such blending can be performed using smoothening functions.

Moreover, the display apparatus further comprises at least one actuator for rotating the at least one optical element, wherein the processor is configured to control the at least one actuator to orient the at least one optical element at the rotational orientation according to the detected gaze direction of the user.

Throughout the present disclosure, the term “actuator” refers to equipment (for example, such as electrical components, mechanical components, magnetic components, polymeric components, and so forth) that is employed to rotate the at least one optical element. Notably, the at least one actuator is driven by an actuation signal. It will be appreciated that the actuation signal could be a mechanical torque, an electric current, a hydraulic pressure, a pneumatic pressure, and the like. As an example, the at least one actuator may comprise a motor, an axle and a plurality of bearings (for example, at least three bearings). Such an actuator may be employed to rotate the at least one optical element (for example, such as a single lens) by applying a mechanical torque to the at least one optical element.

Additionally, optionally, the at least one actuator is controlled to tilt and/or translate the at least one optical element with respect to the image renderer, based upon the detected gaze direction of the user.

Optionally, the at least one actuator is coupled directly to (namely, attached to) the at least one optical element. Alternatively, optionally, the at least one actuator is coupled indirectly to the at least one optical element. Optionally, in such a case, the at least one optical element is arranged on a supporting frame, wherein the supporting frame is attached to the at least one actuator in a manner that the at least one actuator, in operation, rotates the supporting frame, and consequently, the at least one optical element.

It will be appreciated that the at least one actuator is arranged in a manner that the user's view is not obstructed. As an example, when the at least one optical element is implemented as a single mirror, the at least one actuator may be arranged at a back side of the single mirror. In such a case, the at least one actuator would not obstruct the user's view. As another example, when the at least one optical element is implemented as a single lens, the lens may be arranged on a supporting frame and the at least one actuator may be implemented as a friction drive arranged near a periphery of the lens.

It will be appreciated that the optical centre of the at least one optical element may or may not be the same as a centre of rotation. Moreover, it will be appreciated that the at least one optical element is balanced in a manner that a centre of mass of the at least one optical element is at the centre of rotation.

Furthermore, according to an embodiment, the at least one optical element is rotatable at a given rotational speed. Throughout the present disclosure, the term “rotational speed” refers to a number of rotations made by the at least one optical element per unit time, while the term “rotation” refers to a complete rotation (namely, a 360-degrees rotation) made by the at least one optical element about an axis of rotation.

Optionally, the rotational speed of the at least one optical element lies in a range of 80 to 120 rotations per second. More optionally, the rotational speed of the at least one optical element lies in a range of 90 to 110 rotations per second.

Optionally, the at least one actuator is operable to rotate the at least one optical element smoothly. Alternatively, optionally, the at least one actuator is operable to rotate the at least one optical element through multiple discrete positions, such multiple discrete positions being distributed along a rotational trajectory of the at least one optical element.

Optionally, the at least one optical element is rotatable in only one direction, namely either clockwise or anti-clockwise. Alternatively, optionally, the at least one optical element is rotatable in both directions.

In some implementations, the at least one optical element is asymmetrical about its optical axis. Optionally, in such implementations, if the at least one optical element is rotatable in only one direction, an angle of rotation of the at least one optical element lies within a range of 0 degrees to 360 degrees; otherwise, if the at least one optical element is rotatable in both the directions, the angle of rotation of the at least one optical element lies within a range of 0 degrees to 180 degrees. One such example implementation has been illustrated in conjunction with FIG. 8A.

In other implementations, the at least one optical element is symmetrical about its optical axis. Optionally, in such implementations, if the at least one optical element is rotatable in only one direction, the angle of rotation of the at least one optical element lies within a range of 0 degrees to 180 degrees; otherwise, if the at least one optical element is rotatable in both the directions, the angle of rotation of the at least one optical element lies within a range of 0 degrees to 90 degrees. One such example implementation has been illustrated in conjunction with FIG. 7A.

It will be appreciated that the angle of rotation of the at least one optical element is reduced considerably in a case where the at least one optical element is symmetrical as compared to another case where the at least one optical element is asymmetrical. As a result, the at least one actuator is simpler to implement for a symmetrical optical element as compared to an asymmetrical optical element. Moreover, power consumption of the at least one actuator also reduces in the case where the at least one optical element is symmetrical.

Moreover, in this embodiment, the given rotational speed of the at least one optical element is taken into account for controlling the image renderer. By “controlling the image renderer”, it is meant that the processor is configured to drive the image renderer, via a control signal, to render a given image of the sequence of warped images at a certain instant of time and for a certain time duration. Notably, the given image is desired to be rendered only when a perfect or near-perfect alignment between the at least one optical element and the warped image (rendered at the image renderer) is achieved according to the detected gaze direction of the user.

Optionally, the processor is configured to determine a given instant of time at which the image produced on the image plane is to be made visible to the user, based upon:
the given rotational speed of the at least one optical element,
a direction of rotation of the at least one optical element, and
a previous rotational orientation of the at least one optical element.

Beneficially, the given instant of time at which the produced image is to be made visible to the user corresponds to a moment in time at which the first optical portion and the second optical portion of the at least one optical element would optimally align with the first portion and the second portion of the warped image (rendered at the image renderer) while the at least one optical element is rotating. Consequently, various instants of time at which different images produced on the image plane (namely, produced by the sequence of warped images) are to be made visible to the user are spaced unequally in time. It will be appreciated that the human visual system is not capable of discerning any unevenness (namely, flicker) in a timed rendering of the sequence of warped images, namely when the user views the different images produced on the image plane.

During the rotation of the at least one optical element, the rotational orientation of the at least one optical element varies according to the given rotational speed of the at least one optical element. A time period during which the at least one optical element can rotate from a first rotational orientation to a second rotational orientation along a given direction of rotation is inversely proportional to the given rotational speed of the at least one optical element. From the given rotational speed, the direction of rotation, and the previous and current rotational orientations of the at least one optical element, it can be determined when the first optical portion and the second optical portion of the at least one optical element would be aligned with the first portion and the second portion of the warped image rendered at the image renderer, respectively.

It will be appreciated that the different images produced on the image plane are to be made visible to the user, when the first optical portion and the second optical portion of the at least one optical element are aligned with first portions and second portions of corresponding warped images in the sequence of warped images that are rendered at the image renderer, respectively.

For illustration purposes only, there will now be considered an example implementation in which the at least one optical element is rotated at a constant rotational speed of 100 rotations per second. In the example implementation, the at least one optical element would make one complete rotation in 10 milliseconds. There will next be considered that a single rotation of the at least one optical element spans eight discrete and equispaced rotational orientations, represented by P1, P2, P3, P4, P5, P6, P7 and P8; in such a case, it will take 1.25 milliseconds to reach a next consecutive rotational orientation from a given rotational orientation. For the sake of convenience only, there will now be considered that these rotational orientations correspond to compass directions, wherein:

P1 corresponds to the ‘North’ direction,
P2 corresponds to the ‘North-East’ direction,
P3 corresponds to the ‘East’ direction,
P4 corresponds to the ‘South-East’ direction,
P5 corresponds to the ‘South’ direction,
P6 corresponds to the ‘South-West’ direction,
P7 corresponds to the ‘West’ direction, and
P8 corresponds to the ‘North-West’ direction.

As an example, when the gaze direction of the user is detected to be towards a right side of a field of view of the user, a first portion of a given warped image (generated according to the detected gaze direction) lies towards a right side with respect to the user. Accordingly, a given instant of time at which a corresponding produced image is to be made visible is a moment of time at which the first optical portion of the at least one optical portion would be oriented at P3 (for example, towards the right side) for an optimal alignment with the first portion of the given warped image rendered at the image renderer.

There will now be considered a case where the at least one optical element is rotatable in a clockwise direction. If the at least one optical element was previously aligned at P3 for producing a first image at time t0 and is desired to be aligned at P5 for producing a second image, the second image would be made visible to the user at time t0+2.5 milliseconds. Next, if the at least one optical element is desired to be aligned at P1 for producing a third image, the third image would be made visible to the user at time t0+7.5 milliseconds.

Furthermore, optionally, the processor is configured to determine a time duration for which the image produced on the image plane is to be made visible to the user, based upon the given rotational speed of the at least one optical element.

Typically, a perfect or near-perfect alignment of the first optical portion and the second optical portion of the at least one optical element with the first portion and the second portion of the warped image, respectively, is only momentary. Therefore, the produced image is to be made visible to the user for a time duration in which the aforesaid alignment is perfect or near-perfect. During this time duration, a slight change in the aforesaid alignment is miniscule, and therefore, a corresponding slight change in an appearance of the produced image is imperceptible to the user.

Notably, the time duration for which the produced image is to be made visible to the user varies inversely with the given rotational speed of the at least one optical element. In other words, at high rotational speeds, the time duration for achieving a perfect or near-perfect alignment of the at least one optical element with the warped image would be extremely short.

Optionally, the time duration for which the produced image is to be made visible lies in a range of 0.2 microseconds to 2 microseconds. Such a time duration is desired to be short enough to allow the produced image to be made visible precisely during the perfect or near-perfect alignment of the of the least one optical element with the warped image, whilst also being long enough to allow the user to view the produced image properly. Beneficially, the time duration is suitably selected to avoid any visual artefacts or optical distortions that the at least one optical element would introduce during the rotation.

The time duration for which the produced image is to be made visible may, for example, be 0.2, 0.3, 0.4, 0.5, 0.6, 0.7, 0.8, 0.9, 1, 1.1, 1.2, 1.3, 1.4, 1.5, 1.6, 1.7, 1.8, 1.9 or 2 microseconds, or any other intermediate value.

As an example, the time duration for which the produced image is to be made visible may be 0.27 microseconds. In such a case, if the at least one optical element is rotating at the rotational speed of 100 rotations per second, a given point on the at least one optical element would cover a rotational distance of 0.01 degrees along the rotational trajectory. As another example, the time duration for which the produced image is to be made visible may be 1.7 microseconds.

Furthermore, according to an embodiment, the image renderer is to be switched on or brightened at the given instant of time. At the given instant of time, the first optical portion and the second optical portion of the at least one optical element are optimally aligned with the first portion and the second portion of the warped image, respectively, thereby enabling optical de-warping of the warped image to produce the image on the image plane that appears de-warped to the user.

Additionally, optionally, the image renderer is to be kept switched-on or brightened throughout the aforesaid time duration starting from the given instant of time. After the time duration elapses, the image renderer is switched off or dimmed, until the image renderer is required to be switched on or brightened for rendering a next warped image. In this way, the image renderer is controlled to perform the timed rendering of the sequence of warped images.

As an example, when the image renderer is implemented as a projector and a projection screen associated therewith, the projector may be triggered to project the warped image upon the projection screen at the given instant of time. As another example, when the image renderer is implemented as an OLED-based display, the OLED-based display may be switched on to display the warped image at the given instant of time. It will be appreciated that switching-off the OLED-based display after the time duration elapses not only reduces power consumption, but also prolongs a lifetime of the OLED-based display. As yet another example, when the image renderer is implemented as an LCD having a backlight, the backlight may be triggered to adjust a brightness of the LCD.

According to another embodiment, the display apparatus further comprises an optical filter arranged on an optical path between the image renderer and the user's eye, wherein the processor is configured to control the optical filter to allow the projections of the first and second portions of the warped image to pass through the optical filter at the given instant of time.

Hereinabove, the term “optical filter” refers to a device that, when controlled, either allows or prevents transmission of light therethrough. Therefore, when arranged as described above, the optical filter either allows or prevents transmission of the projection of the warped image emanating from the image renderer. Beneficially, the optical filter allows the projection of the warped image to pass therethrough at the given instant of time and for the aforesaid time duration.

The optical filter can be implemented as an optical chopper, a leaf shutter, an electronic shutter and the like.

Moreover, the present disclosure also relates to the method as described above. Various embodiments and variants disclosed above, with respect to the aforementioned first aspect, apply mutatis mutandis to the method.

Optionally, the step of generating the warped image comprises adjusting an intensity of the first portion and the second portion of the warped image in a manner that, upon being differently magnified, the projections of the first portion and the second portion of the warped image produce the image on the image plane that appears to have a uniform brightness across the image.

Optionally, the display apparatus further comprises at least one actuator for rotating the at least one optical element, wherein the method further comprises controlling the at least one actuator to orient the at least one optical element at the rotational orientation according to the detected gaze direction of the user.

Optionally, the at least one optical element is rotatable at a given rotational speed, wherein the method further comprises determining a given instant of time at which the image produced on the image plane is to be made visible to the user, based upon the given rotational speed of the at least one optical element, a direction of rotation of the at least one optical element and a previous rotational orientation of the at least one optical element.

Additionally, optionally, the method further comprises determining a time duration for which the image produced on the image plane is to be made visible to the user, based upon the given rotational speed of the at least one optical element.

Optionally, the time duration for which the image is to be made visible lies in a range of 0.2 microseconds to 2 microseconds.

Moreover, optionally, the method further comprises switching on or brightening the image renderer at the given instant of time.

Alternatively, optionally, the display apparatus further comprises an optical filter arranged on an optical path between the image renderer and the user's eye, wherein the method further comprises controlling the optical filter to allow the projections of the first and second portions of the warped image to pass through the optical filter at the given instant of time.

Furthermore, optionally, in the method, the at least one optical element is asymmetrical with respect to its optical axis, the first optical portion and the second optical portion being positioned asymmetrically with respect to the optical axis of the at least one optical element.

Alternatively, optionally, in the method, the at least one optical element is symmetrical with respect to its optical axis, the first optical portion surrounding an optical centre of the at least one optical element, the second optical portion surrounding the first optical portion.

### DETAILED DESCRIPTION OF THE DRAWINGS

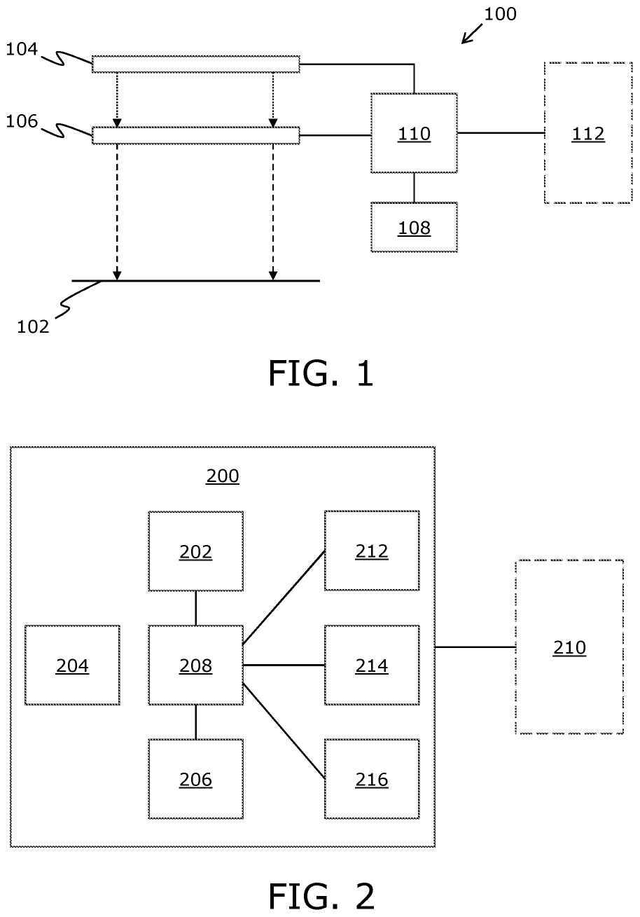

Referring to FIG. 1, illustrated is a schematic diagram of a display apparatus 100 for producing an image having a spatially-variable angular resolution on an image plane 102, in accordance with an embodiment of the present disclosure. The display apparatus 100 comprises an image renderer per eye (depicted as an image renderer 104, for the sake of simplicity), at least one optical element (depicted as an optical element 106, for the sake of simplicity), means 108 for detecting a gaze direction of a user with respect to the image plane 102, and a processor 110 coupled to the image renderer 104 and said means 108.

The optical element 106 comprises at least a first optical portion and a second optical portion having different optical properties with respect to magnification, and is rotatable. The processor 110 or an image source 112 communicably coupled to the processor 110 is configured to generate a warped image based upon the detected gaze direction of the user and the optical properties of the first optical portion and the second optical portion.

The processor 110 is configured to control the image renderer 104 to render the warped image, whilst controlling a rotational orientation of the at least one optical element 106 in a manner that the first optical portion and the second optical portion are oriented according to the detected gaze direction of the user, wherein projections of a first portion and a second portion of the warped image are to be differently magnified by the first optical portion and the second optical portion, respectively, to produce the image on the image plane 102 in a manner that the produced image appears de-warped to the user.

FIG. 1 is merely an example, which should not unduly limit the scope of the claims herein. It is to be understood that the specific designation for the display apparatus 100 is provided as an example and is not to be construed as limiting the display apparatus 100 to specific numbers or types of image renderers, optical elements, means for detecting the gaze direction, and processors. A person skilled in the art will recognize many variations, alternatives, and modifications of embodiments of the present disclosure.

Referring to FIG. 2, illustrated is a schematic diagram of a display apparatus 200 for producing an image having a spatially-variable angular resolution on an image plane, in accordance with a specific embodiment of the present disclosure. The display apparatus 200 comprises an image renderer per eye (depicted as an image renderer 202 for the sake of simplicity), at least one optical element (depicted as an optical element 204 for the sake of simplicity), means 206 for detecting a gaze direction of a user, and a processor 208 coupled to the image renderer 202 and said means 206.

The processor 208 or an image source 210 communicably coupled to the processor 208 is configured to generate a warped image based upon the detected gaze direction of the user and optical properties of a first optical portion and a second optical portion of the optical element 204. The processor 208 is configured to control the image renderer 202 to render the warped image, whilst controlling a rotational orientation of the at least one optical element 204 in a manner that the first optical portion and the second optical portion are oriented according to the detected gaze direction of the user, wherein projections of a first portion and a second portion of the warped image are to be differently magnified by the first optical portion and the second optical portion, respectively, to produce the image on the image plane in a manner that the produced image appears de-warped to the user.

The display apparatus 200 further comprises at least one actuator (depicted as an actuator 212 for the sake of simplicity) for rotating the optical element 204, wherein the processor 208 is configured to control the actuator 212 to orient the optical element 204 at the rotational orientation according to the detected gaze direction of the user.

Moreover, optionally, the display apparatus 200 further comprises an optical filter 214, wherein the processor 208 is configured to control the optical filter 214 to allow projections of the first and second portions of a warped image to pass through the optical filter 214 at the given instant of time.

Furthermore, optionally, the display apparatus 200 comprises means 216 for tracking a head orientation of a user, wherein the head orientation is to be tracked when the display apparatus 200 in operation is worn by the user. In such a case, the tracked head-orientation of the user is utilized for generating a warped image that conforms to a current perspective of the user.

FIG. 2 is merely an example, which should not unduly limit the scope of the claims herein. It is to be understood that the specific designation for the display apparatus 200 is provided as an example and is not to be construed as limiting the display apparatus 200 to specific numbers or types of image renderers, optical elements, means for detecting the gaze direction, processors, actuators, optical filters and means for tracking the head orientation. A person skilled in the art will recognize many variations, alternatives, and modifications of embodiments of the present disclosure.

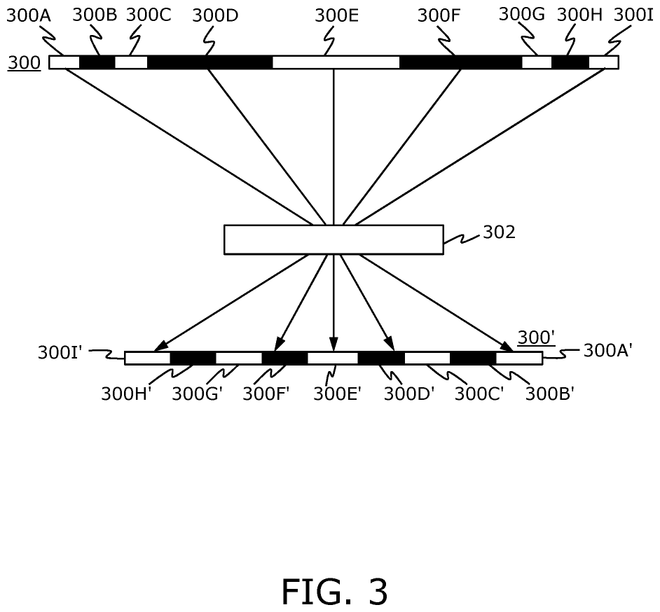

Referring to FIG. 3, illustrated is a schematic illustration of how different portions of a warped image 300 are differently magnified by an optical element 302 to produce an image 300′ on an image plane, in accordance with an embodiment of the present disclosure. The warped image 300 is rendered via an image renderer, wherefrom a projection of the warped image 300 is directed towards a user's eye. There are shown different portions 300A, 300B, 300C, 300D, 300E, 300F, 300G, 300H and 3001 of the warped image 300. Notably, the portions 300D, 300E and 300F collectively constitute a first portion of the warped image 300, while the portions 300A, 300B, 300C, 300G, 300H and 3001 collectively constitute a second portion of the warped image 300.

Upon passing through the optical element 302, projections of the first portion and the second portion of the warped image 300 are differently magnified to produce on the image plane a first de-warped portion and a second de-warped portion of the produced image 300′, respectively. The first de-warped portion of the image 300′ includes de-warped portions 300D′, 300E′ and 300F′, while the second de-warped portion includes de-warped portions 300A′, 300B′, 300C′, 300G′, 300H′ and 3001′. Notably, the regions 300D′, 300E′, and 300F′ are de-magnified, while the regions 300A′, 300B′, 300C′, 300G′, 300H′ and 3001′ are magnified.

FIG. 3 is merely an example, which should not unduly limit the scope of the claims herein. A person skilled in the art will recognize many variations, alternatives, and modifications of embodiments of the present disclosure. For example, projections of certain portions of the warped image may be neither magnified nor de-magnified.

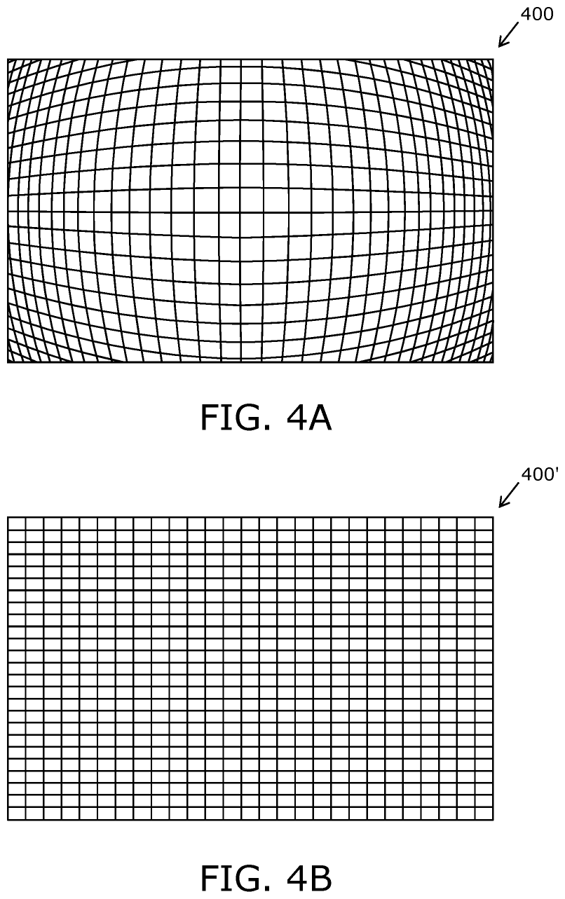

Referring to FIG. 4A, illustrated is an example illustration of a warped image 400 as rendered via an image renderer, in accordance with an embodiment of the present disclosure. The warped image 400 has a same angular resolution across an image rendering surface of the image renderer.

Referring to FIG. 4B, illustrated is an example illustration of an image 400′ that is produced on an image plane when the warped image 400 passes through or reflects from at least one optical element arranged on an optical path between the image renderer and the image plane, in accordance with an embodiment of the present disclosure. Notably, projections of a first portion and a second portion of the warped image 400 are differently magnified by a first optical portion and a second optical portion of the at least one optical element, respectively, to produce the image 400′ on the image plane in a manner that the produced image 400′ appears de-warped to the user.

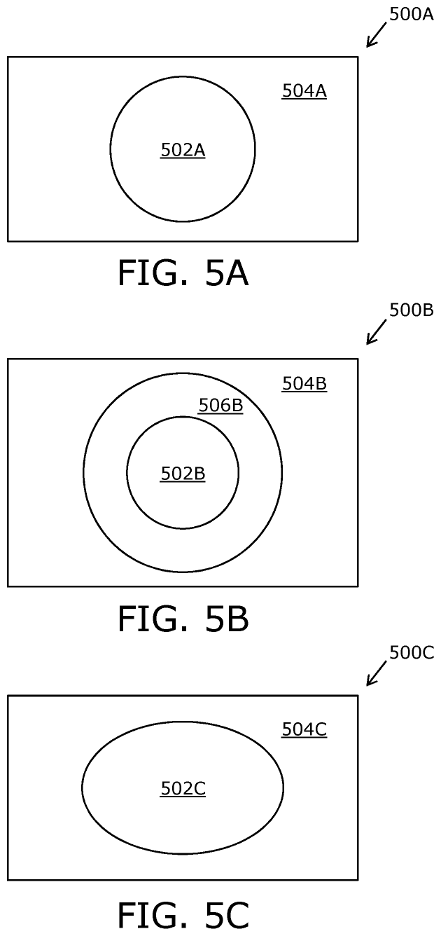

Referring to FIGS. 5A, 5B and 5C, illustrated are example schematic illustrations of de-warped portions of images that are produced on an image plane, said de-warped portions having different angular resolutions, in accordance with different embodiments of the present disclosure.

In FIG. 5A, a produced image 500A comprises a first de-warped portion 502A and a second de-warped portion 504A. The angular resolution of the first de-warped portion 502A is greater than the angular resolution of the second de-warped portion 504A, pursuant to embodiments of the present disclosure. As shown, the shape of the first de-warped portion 502A is substantially circular, pursuant to an embodiment of the present disclosure. As a result, the angular resolution of a given de-warped portion of the produced image 500A (measured as a function of an angular distance between the given de-warped portion of the produced image 500A and a centre of the produced image 500A) would vary similarly in different directions (for example, horizontal and vertical directions).

In FIG. 5B, a produced image 500B comprises a first de-warped portion 502B, a second de-warped portion 504B and an intermediary de-warped portion 506B between the first de-warped portion 502B and the second de-warped portion 504B. The angular resolution of the intermediary de-warped portion 506B is greater than the angular resolution of the second de-warped portion 504B, but smaller than the angular resolution of the first de-warped portion 502B. As shown, the shape of the first de-warped portion 502B and the intermediary de-warped portion 506B is substantially circular, pursuant to an embodiment of the present disclosure. As a result, the angular resolution of a given de-warped portion of the produced image 500B (measured as a function of an angular distance between the given de-warped portion of the produced image 500B and a centre of the produced image 500B) would vary similarly in different directions (for example, the horizontal and vertical directions).

In FIG. 5C, a produced image 500C comprises a first de-warped portion 502C and a second de-warped portion 504C. The angular resolution of the first de-warped portion 502C is greater than the angular resolution of the second de-warped portion 504C. As shown, the shape of the first de-warped portion 502C is substantially elliptical, pursuant to another embodiment of the present disclosure. As a result, the angular resolution of a given de-warped portion of the produced image 500C (measured as a function of an angular distance between the given de-warped portion of the produced image 500C and a centre of the produced image 500C) would vary differently in different directions.

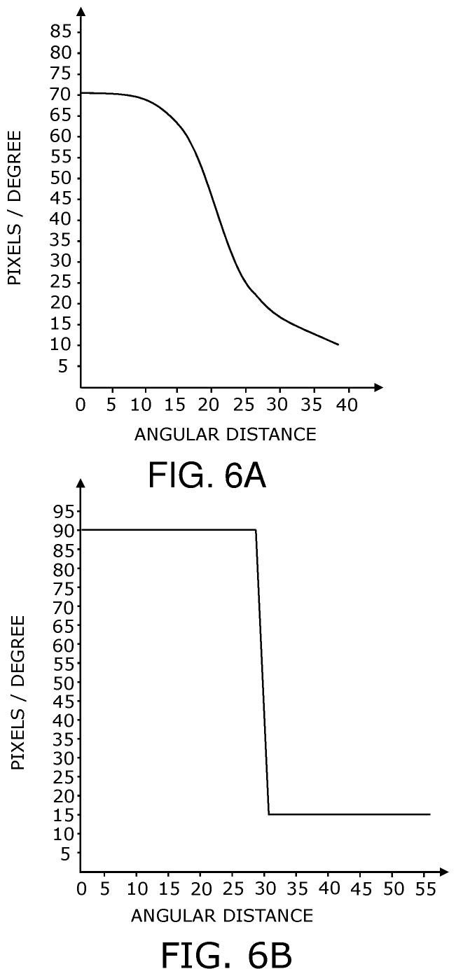

Referring to FIGS. 6A and 6B, illustrated are example graphical representations of an angular resolution of a produced image as a function of an angular distance between a centre of a first de-warped portion of the produced image and an edge of the produced image, the produced image having a spatially-variable angular resolution, in accordance with different embodiments of the present disclosure.

In FIG. 6A, the angular resolution of the produced image varies as a non-linear gradient function across an angular width of the produced image. Notably, the angular resolution is the maximum near the centre of the first de-warped portion of produced image, and decreases non-linearly on going from the centre of the first de-warped portion towards an edge of the produced image. As an example, the angular resolution of the first de-warped portion (namely, a de-warped portion spanning approximately zero to 30 degrees of the angular width) of the produced image is much greater than the angular resolution of a second de-warped portion (namely, a de-warped portion spanning approximately 30 to 80 degrees of the angular width) of the produced image.

In FIG. 6B, the angular resolution of the produced image varies as a step gradient function across an angular width of the produced image. Notably, the angular resolution varies across the produced image in a step-wise manner. As an example, the angular resolution of the first de-warped portion (namely, a de-warped portion spanning approximately zero to 60 degrees of the angular width) of the produced image is much greater than the angular resolution of a second de-warped portion (namely, a portion spanning approximately 60 to 110 degrees of the angular width) of the produced image.

Referring to FIG. 7A, illustrated is a schematic illustration of an example implementation where a symmetrical optical element 702 is rotated with respect to an image renderer 704 that is employed to render a warped image, while FIG. 7B is an example graphical representation of an angular resolution of a de-warped portion of an image produced on an image plane as a function of an angular distance between the de-warped portion of the produced image and a centre of the produced image, the warped image being optically de-warped using the symmetrical optical element 702 to produce said image, in accordance with an embodiment of the present disclosure.

In this example implementation, the symmetrical optical element 702 is depicted as a lens that is symmetrical about its optical axis. The symmetrical optical element 702 comprises a first optical portion 706 and a second optical portion 708 having different optical properties with respect to magnification. The first optical portion 706 is shown to be substantially elliptical in shape.

In FIG. 7A, there is also shown an optical centre (depicted by a black dot) of the first optical portion 706, which is also a centre of rotation of the symmetrical optical element 702. Two lines representing X and Y directions pass through the centre of rotation, which overlaps with the centre of the warped image. The symmetrical optical element 702 is rotated at a given rotational speed with respect to the image renderer 704. Specifically, the symmetrical optical element 702 is rotated (namely, about the centre of rotation) with respect to an image rendering surface of the image renderer 704.

The symmetrical optical element 702 is rotated to a given rotational orientation, such that the first optical portion 706 and the second optical portion 708 are aligned according to a detected gaze direction of a user.

When moving from a first rotational orientation to a second rotational orientation (namely, with respect to a change in the user's gaze direction), the symmetrical optical element 702 is required to be rotated at an angle that lies in:
a range of 0 degrees to 180 degrees, when the symmetrical optical element 702 rotates in only one direction, or
a range of 0 degrees to 90 degrees, when the symmetrical optical element 702 rotates in both directions.

As shown in FIG. 7B, the angular resolution is the maximum near the centre of the produced image, and decreases non-linearly on going from the centre towards an edge of the produced image. The angular resolution of a de-warped portion of the produced image that spans approximately from −10 degrees to +10 degrees of a field of view along the X-direction and from −20 degrees to +20 degrees of the field of view along the Y-direction is much greater than the angular resolution of a remaining de-warped portion of the produced image.

Referring next to FIG. 8A, illustrated is a schematic illustration of another example implementation where an asymmetrical optical element 802 is rotated with respect to an image renderer 804 that is employed to render a warped image, while FIG. 8B is an example graphical representation of an angular resolution of a de-warped portion of an image produced on an image plane as a function of an angular distance between the de-warped portion of the produced image and a centre of the produced image, the warped image being optically de-warped using the asymmetrical optical element 802 to produce said image, in accordance with another embodiment of the present disclosure.

In this example implementation, the asymmetrical optical element 802 is depicted as a lens that is asymmetrical about its optical axis. The asymmetrical optical element 802 comprises a first optical portion 806 and a second optical portion 808 having different optical properties with respect to magnification. The first optical portion 806 is shown to be substantially elliptical in shape.

In FIG. 8A, there is also shown an optical centre ‘O’ of the first optical portion 806, and a centre of rotation (depicted by a black dot) of the asymmetrical optical element 802. Two lines representing X′ and Y′ directions pass through the centre of rotation, which overlaps with the centre of the warped image. As the optical centre ‘O’ of the first optical portion 806 is not the same as the centre of rotation, the asymmetrical optical element 802 is rotated (namely, about the centre of rotation) to cover a circular area of the image renderer 804 using the first optical portion 806. The asymmetrical optical element 802 is rotated at a given rotational speed with respect to the image renderer 804. Specifically, the asymmetrical optical element 802 is rotated with respect to an image rendering surface of the image renderer 804.

The asymmetrical optical element 802 is rotated to a given rotational orientation, such that the first optical portion 806 and the second optical portion 808 are aligned according to a detected gaze direction of a user.

When moving from a first rotational orientation to a second rotational orientation, the asymmetrical optical element 802 is required to be rotated at an angle that lies in:
a range of 0 degrees to 360 degrees, when the asymmetrical optical element 802 rotates in only one direction, or
a range of 0 degrees to 180 degrees, when the asymmetrical optical element 802 rotates in both directions.

As shown in FIG. 8B, the angular resolution of a portion of the produced image that spans approximately from −10 degrees to +10 degrees of a field of view along the X′-direction and from −5 degrees to +25 degrees of the field of view along the Y′-direction is much greater than the angular resolution of a remaining portion of the produced image.

FIGS. 7A, 7B, 8A and 8B are merely examples, which should not unduly limit the scope of the claims herein. A person skilled in the art will recognize many variations, alternatives, and modifications of embodiments of the present disclosure. It will be appreciated that the optical elements 702 and 802 have been depicted as lenses, for the sake of convenience only; the optical elements 702 and 802 are not limited to a particular type of optical element. In other words, the optical elements 702 and 802 can be implemented as a single lens or mirror having a complex shape or as a configuration of lenses and/or mirrors.

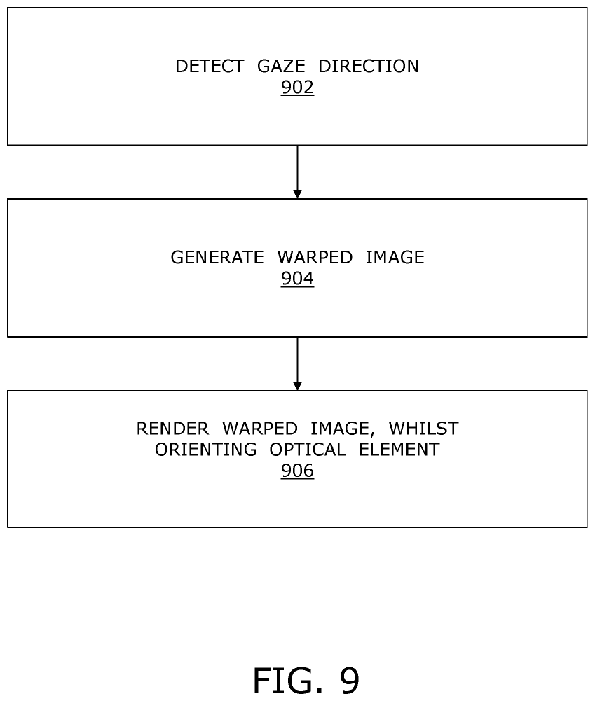

Referring to FIG. 9, illustrated are steps of a method of producing an image having a spatially variable resolution on an image plane, in accordance with an embodiment of the present disclosure. The method is depicted as a collection of steps in a logical flow diagram, which represents a sequence of steps that can be implemented in hardware, software, or a combination thereof, for example as aforementioned.

The method is implemented via a display apparatus comprising an image renderer and at least one optical element arranged on an optical path between the image renderer and the image plane. The at least one optical element comprises at least a first optical portion and a second optical portion having different optical properties with respect to magnification.

At a step 902, a gaze direction of a user is detected with respect to the image plane.

At a step 904, a warped image is generated based upon the detected gaze direction of the user and the optical properties of the first optical portion and the second optical portion of the at least one optical element.

At a step 906, the warped image is rendered via the image renderer, whilst controlling a rotational orientation of the at least one optical element in a manner that the first optical portion and the second optical portion are oriented according to the detected gaze direction of the user. Projections of a first portion and a second portion of the warped image are differently magnified by the first optical portion and the second optical portion, respectively, to produce the image on the image plane in a manner that the produced image appears de-warped to the user.

The steps 902 to 906 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display apparatus for producing an image having a spatially-variable angular resolution on an image plane, the display apparatus comprising:
an image renderer per eye;
at least one optical element arranged on an optical path between the image renderer and the image plane, the at least one optical element comprising at least a first optical portion and a second optical portion having different optical properties with respect to magnification, the at least one optical element being rotatable;
means for detecting a gaze direction of a user with respect to the image plane; and
a processor coupled to the image renderer and said means, wherein the processor or an image source communicably coupled to the processor is configured to generate a warped image based upon the detected gaze direction of the user and the optical properties of the first optical portion and the second optical portion,
wherein the processor is configured to control the image renderer to render the warped image, whilst controlling a rotational orientation of the at least one optical element in a manner that the first optical portion and the second optical portion are oriented according to the detected gaze direction of the user, wherein projections of a first portion and a second portion of the warped image are to be differently magnified by the first optical portion and the second optical portion, respectively, to produce the image on the image plane in a manner that the produced image appears de-warped to the user.

2. The display apparatus of claim 1, wherein, when generating the warped image, the processor or the image source is configured to adjust an intensity of the first portion and the second portion of the warped image in a manner that, upon being differently magnified, the projections of the first portion and the second portion of the warped image produce the image on the image plane that appears to have a uniform brightness across the image.

3. The display apparatus of claim 1, further comprising at least one actuator for rotating the at least one optical element, wherein the processor is configured to control the at least one actuator to orient the at least one optical element at the rotational orientation according to the detected gaze direction of the user.

4. The display apparatus of claim 1, wherein the at least one optical element is rotatable at a given rotational speed, wherein the processor is configured to determine a given instant of time at which the image produced on the image plane is to be made visible to the user, based upon the given rotational speed of the at least one optical element, a direction of rotation of the at least one optical element and a previous rotational orientation of the at least one optical element.

5. The display apparatus of claim 4, wherein the processor is configured to determine a time duration for which the image produced on the image plane is to be made visible to the user, based upon the given rotational speed of the at least one optical element.

6. The display apparatus of claim 5, wherein the time duration for which the image is to be made visible lies in a range of 0.2 microseconds to 2 microseconds.

7. The display apparatus of claim 4, wherein the image renderer is to be switched on or brightened at the given instant of time.

8. The display apparatus of claim 4, further comprising an optical filter arranged on an optical path between the image renderer and a user's eye, wherein the processor is configured to control the optical filter to allow the projections of the first and second portions of the warped image to pass through the optical filter at the given instant of time.

9. The display apparatus of claim 1, wherein the at least one optical element is asymmetrical with respect to its optical axis, the first optical portion and the second optical portion being positioned asymmetrically with respect to the optical axis of the at least one optical element.

10. The display apparatus of claim 1, wherein the at least one optical element is symmetrical with respect to its optical axis, the first optical portion surrounding an optical centre of the at least one optical element, the second optical portion surrounding the first optical portion.

11. A method of producing an image having a spatially-variable angular resolution on an image plane, the method being implemented via a display apparatus comprising
an image renderer and at least one optical element arranged on an optical path between the image renderer and the image plane, the method comprising:
detecting a gaze direction of a user with respect to the image plane;
generating a warped image based upon the detected gaze direction of the user and optical properties of a first optical portion and a second optical portion of the at least one optical element, wherein the first optical portion and the second optical portion have different optical properties with respect to magnification; and
rendering the warped image via the image renderer, whilst controlling a rotational orientation of the at least one optical element in a manner that the first optical portion and the second optical portion are oriented according to the detected gaze direction of the user, wherein projections of a first portion and a second portion of the warped image are differently magnified by the first optical portion and the second optical portion, respectively, to produce the image on the image plane in a manner that the produced image appears de-warped to the user.

12. The method of claim 11, wherein the step of generating the warped image comprises adjusting an intensity of the first portion and the second portion of the warped image in a manner that, upon being differently magnified, the projections of the first portion and the second portion of the warped image produce the image on the image plane that appears to have a uniform brightness across the image.

13. The method of claim 11, wherein the display apparatus further comprises at least one actuator for rotating the at least one optical element, wherein the method further comprises controlling the at least one actuator to orient the at least one optical element at the rotational orientation according to the detected gaze direction of the user.

14. The method of claim 11, wherein the at least one optical element is rotatable at a given rotational speed, wherein the method further comprises determining a given instant of time at which the image produced on the image plane is to be made visible to the user, based upon the given rotational speed of the at least one optical element, a direction of rotation of the at least one optical element and a previous rotational orientation of the at least one optical element.

15. The method of claim 14, wherein the method further comprises determining a time duration for which the image produced on the image plane is to be made visible to the user, based upon the given rotational speed of the at least one optical element.

16. The method of claim 15, wherein the time duration for which the image is to be made visible lies in a range of 0.2 microseconds to 2 microseconds.

17. The method of claim 14, wherein the method further comprises switching on or brightening the image renderer at the given instant of time.

18. The method of claim 14, wherein the display apparatus further comprises an optical filter arranged on an optical path between the image renderer and a user's eye, wherein the method further comprises controlling the optical filter to allow the projections of the first and second portions of the warped image to pass through the optical filter at the given instant of time.

19. The method of claim 11, wherein the at least one optical element is asymmetrical with respect to its optical axis, the first optical portion and the second optical portion being positioned asymmetrically with respect to the optical axis of the at least one optical element.

20. The method of claim 11, wherein the at least one optical element is symmetrical with respect to its optical axis, the first optical portion surrounding an optical centre of the at least one optical element, the second optical portion surrounding the first optical portion.
